(19) United States
(12) Patent Application Publication
(10) Pub. No.: US 2020/0085071 A1
(43) Pub. Date: Mar. 19, 2020

(54) Fruit-Type Dehydration System And Process

(71) Applicant: Dream Builders Agriculture Products, LLC, Pago Pago (AS)

(72) Inventors: Alexander E. Jennings, Pago Pago (AS); Niyom Nakarin, Rosamond, CA (US)

(21) Appl. No.: 16/501,111

(22) Filed: Jan. 31, 2019

Related U.S. Application Data
(60) Provisional application No. 62/624,324, filed on Jan. 31, 2018.

(51) Int. Cl. A23B 7/02; A23B 7/028; A23N 12/08

(52) U.S. Cl. CPC A23B 7/0205; A23V 2002/00; A23N 12/08; A23B 7/028

(57) ABSTRACT

A method and system for drying a product, such as breadfruit, includes a container (such as an intermodal freight container); a rack assembly for holding shelf assemblies that include a drying rack, a baffle, and an exhaust fan; and an air supply. The air supply system can include a hot air fan for supplying warm air from a solar heat source or other heat source. The heated air for breadfruit at the hot sides of the drying racks is 105-120 F.

### CROSS- REFERENCE TO RELATED APPLICATIONS

This claims priority to U.S. patent application Ser. No. 62/624,324 filed Jan. 31, 2018, the disclosure of which is hereby incorporated by reference as if set forth in its entirety herein.

### BACKGROUND

Breadfruit, banana, and figs are common stables in the nations of the Pacific and in certain parts of the world. Often the crops have drawbacks that inhibit their commercialization. Breadfruit, for example, is a crop that is susceptible to fermentation, discoloration, and a gritty-like texture with a distinctive smell when preserved into flour. For the most part breadfruit is used for human consumption only during harvesting season with the majority of it being wasted or used to feed farm animals, as breadfruit is not commonly preserved and commercialized as food product.

Many climates and regions of the world are suitable for growing fruit crops. But lack of infrastructure often makes growing on a commercial scale infeasible.

### SUMMARY

A drying process can dry and preserve fruit products having a relatively high water-content, such as (without limitation) breadfruit and banana. The dried product can be stored and later used as a food product, cooked into its own product (such without limitation grits or hash browns), or can be further processed into a flour product. As an example, the drying apparatus and process dries and preserves breadfruit, which can be further processed into flour that avoids discoloration, fermentation, gritty texture and any noticeable smell, while maintain all its nutritional properties. The drying process can introduce low-med heat (115-120 F) to shredded or chopped breadfruit, with a vacuum system to remove moist air.

### BRIEF DESCRIPTION OF THE FIGURES

FIG. 1 is sketch of a drying unit system for drying a product, such as breadfruit.

FIG. 2 is a perspective view of a rack assembly portion of the system of FIG. 1.

FIG. 3 is another perspective view of a rack assembly portion of the system of FIG. 1.

FIG. 4 is another perspective view of a rack assembly portion of the system of FIG. 1.

FIG. 5 is a perspective view of an exterior of the system of FIG. 1.

FIG. 6 is a perspective view of the drying tray of the system of FIG. 1, having breadfruit spread on the drying tray.

FIG. 7 is a view of a flour formed of breadfruit dried by the system of FIG. 1.

### DETAILED DESCRIPTION OF PREFERRED EMBODIMENT

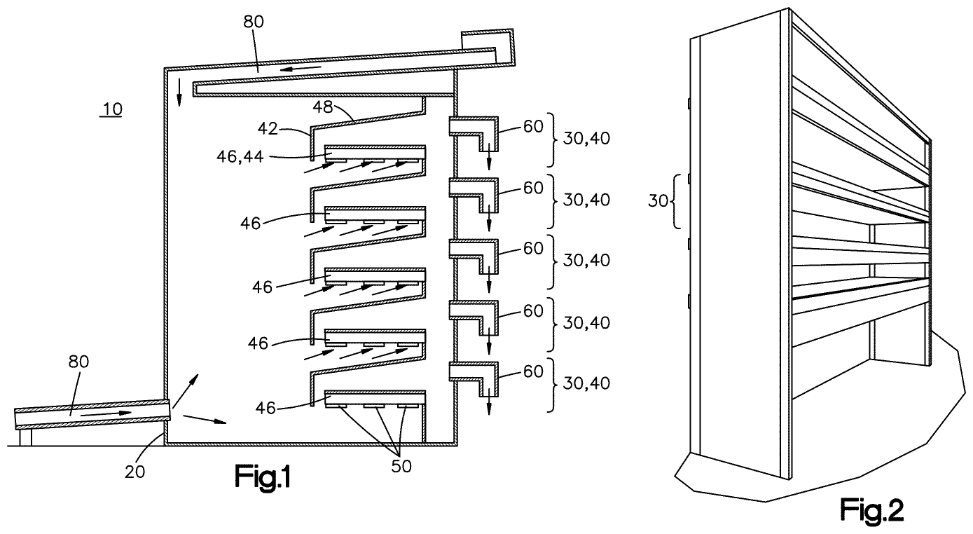

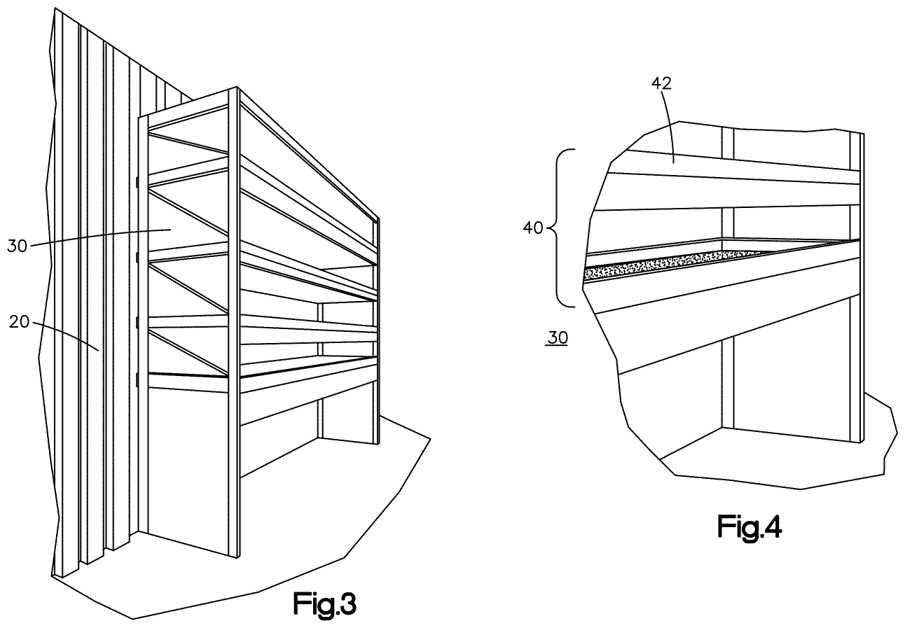

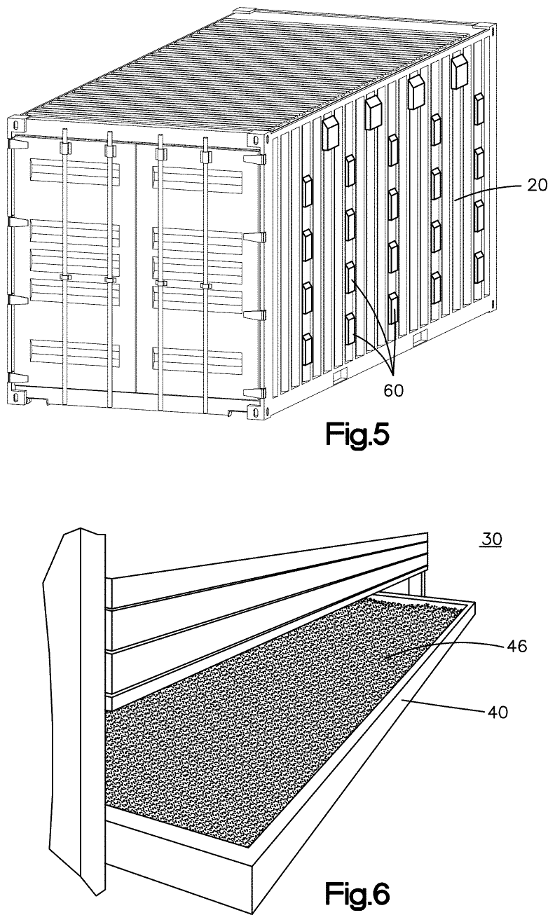

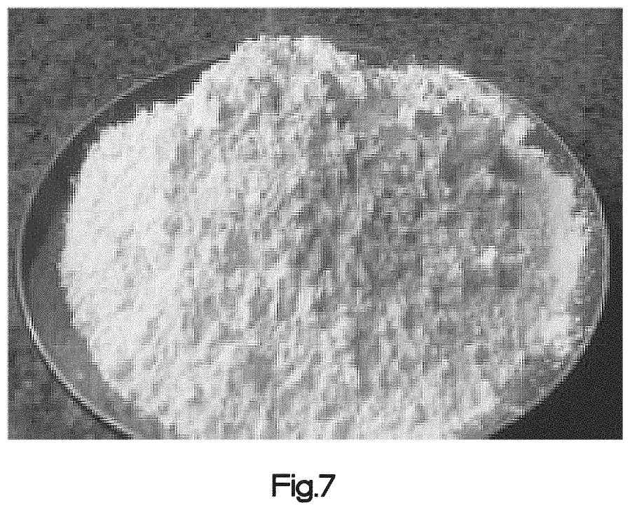

Referring to the figures, a system 10 for processing a fruit product, such as breadfruit, is referred to as a Natural Solar Vacuum Design (NSVD). The NSVD system 10 incorporates the drying process and is capable of being built or shipped to remote locations. System 10 incorporates solar power with AC electric (such as may be supplied by a power grid or local generator) and gas heaters for sustained operation. FIG. 1 schematically illustrates a system having five shelves. FIGS. 2 et seq. illustrate a system having two units of four shelves each.

The system 10 includes a standard shipping container (that is, an intermodal freight container) 20 (preferably a 20 foot container). A rack assembly 30 holds four shelf assemblies 40. In the embodiment of the figures, rack assembly 30 is formed by two box-like structures having dimensions of eight feet long by four feet wide by nine feet high. Each shelf assembly 40 has dimensions of eight feet long by four feet wide.

Each shelf assembly 40 includes a door panel 42, a drying rack or shelf 44, and a baffle 46. Door panel 42 separates the hot section H of the process from the vacuum section V. Because the rack assembly 30 is boxed against the wall of container 20, hot section H is isolated from vacuum section V by the breadfruit when placed on the shelves 40. Underneath each shelf assembly 40 is one or more electric fans 50 to blow hot air to the breadfruit shreds. Fans 50 are illustrated in FIG. 1. Any number of fans may be used.

On the vacuum side V, thirty-two exhaust fans 60 are installed through the container wall in rows of 4 to align with each shelf of the Rack Assembly. Each shelf has four fans 60 that evacuate moist air from vacuum side V. To illustrate one way to operate the system 10, at approximately 80 F the exhaust fans 60 are energized to vacuum out the moisture, while maintaining 105-120 F in the hot section. Temperature control switches can be integral with the fan or placed inside of the container. Controls can be by any means, as will be understood by persons familiar with temperature and process controls.

FIG. 4 illustrates a center door panel 42 in an open position enabling a shelf 44 to be filled with shredded breadfruit. And upper shelf door panel 42 is closed, which exposes the bottom fans that transfer hot air to breadfruit shreds on the top shelf, while isolating the breadfruit shreds to the vacuum side.

As illustrated in the figures, each shelf assembly 40 includes a tray 46 that rests on the shelf 44 and holds the breadfruit. Each drying tray 46 may include small holes or a screen to permit air to pass through. Alternatively, the tray 46 may be solid (that is, continuous without holes or screens) such that air passes over the breadfruit.

The baffle 48, as illustrated schematically in FIG. 1, is an angled barrier above each shelf. Thus, each shelf assembly 40 is referred to as a drying unit. An open outlet plenum V is shown in the photos as the exhaust fans 60 draw from each drying unit 40. The present invention is not limited to an open outlet plenum, but rather encompasses an exhaust fans or fans for each drying unit such that the drying unit forms an enclosed space that is evacuated only by the exhaust fan dedicated to the particular drying unit.

A pair of solar panels 80 can be employed to supply heated air to air inlets 82 formed in the container wall 20. The solar panels 80 can be direct heat type such that solar energy is used to heat incoming air, such as air inducted into the container via the air inlets by the exhaust fans 60. The solar panels can be of any type. For example, the panel can be formed by two four-feet wide by eight-feet long panels formed by a box that is eight feet long by four feet wide. The box can house continuous rows of tubes, which can be made from rows of aluminum cans. The tops and bottoms of the aluminum cans are removed and glued to form the tubes. The entire inside of the box and all the rows of aluminum cans can be painted black to absorb heat. One side of the solar panel is attached to the dryer through a series of pipes to transfer heat from the solar panel to the hot section. The other side of the solar dryer is open with a screen mesh and rat wire to allow air to flow in while keeping bugs and critters out. The solar panel is positioned at an angle to allow the natural flow of hot air into the dryer, also with the assistance of shelf fans transferring hot air to the breadfruit shreds. During hot conditions the solar heat panels 80 along with the steel construction of the dryer can maintain the needed heat for the drying operation. Other heat source can be electric dehydrators or gas heaters, for example, as needed.

The system 10 can be incorporated into buildings and warehouse like structures. Housings, rooms or other areas within these structures and can be built and designed to incorporate the racks and chambers-like assemblies, apply other heating sources in addition to solar heat, and other types of vacuum systems to achieve similar results. Thus, the present invention is not limited to employing a shipping container 20 for its housing.

The following are specific procedures for preparing and drying breadfruit, which procedures can be modified as needed to accommodate local conditions and other variables:

First the breadfruit preferably has the right maturity for normal consumption. Preparing the breadfruit for drying ensures or enhances proper drying and improves the texture of the dried product, such as eliminating gritty like texture. The inventors also surmise that the process is best when started the evening before the actual drying when using the Natural Solar Vacuum Dryer system 10.

As soon as practically possible after picking the breadfruit, the raw breadfruit preferably is peeled and placed in water over night. Conventional additives as needed may be added to the water. The steps, the inventors surmise, allow the sap of the breadfruit to drain, while the water helps to preserve the parameters of the breadfruit until drying, which also reduces the gritty texture.

After 4 to 24 hours soaking, preferably 6 to 16 hours, or 8 to 12 hours soaking, and in the embodiment in which that breadfruit soaks in water overnight, 10 hours of soaking, the breadfruit is removed from the soaking liquid and rinsed with water. Then (for example, the morning following the harvesting and soaking), the breadfruit can be cut, such as into quarters, and the core and seeds removed. The product can then be shredded, such as in a food processor or like machine. The shredding step easies the drying process of the breadfruit and enables thorough drying at a lower temperature than if not shredded. Further, the shredded breadfruit itself may have commercial food uses.

The inventors surmise that the drying sequence avoids the prior art problems of fermentation, discoloration, and the distinctive smell of breadfruit, by ensuring that any moisture is removed and not allowed to stabilize on or around the breadfruit. The process, as explained herein, may be applied for processing/drying other fruit or food products.

The shredded breadfruit may then be processed in system 10 by spreading the shredded breadfruit, preferably evenly at approximately 1″ thick on the drying trays 46. The trays bearing the shredded breadfruit can be placed in the drying rack 40. A heat, such as a gas heater, or a dehydrator can be employed, depending on many variables, such as local weather.

Upon reaching a temperature of approximately 80 F, exhaust fans 60 may be turned on to remove moist air from the vacuum side V of the system. The inventors surmise that removing moist air from above the breadfruit also is a factor in diminishing discoloration and fermentation to the breadfruit. After an initial drying period, such as approximately two hours, the shredded breadfruit on the trays can be stirred and mixed to enhance even drying. Then the shredded breadfruit can be stirred or mixed approximately every 1½ to 2 hours.

On a hot day, the dried breadfruit should ready for harvest after 14-15 hours of drying. The moisture content of the shredded breadfruit should be between 10 and 13%. The drying time may vary according to ambient temperatures and humidity, among other factors. Once the breadfruit is dried it can be milled into flour, or packaged in the shred form as breadfruit grits for different food applications.

The present invention has been described with respect to specific examples. The present invention is not limited to any specific parameter (such as dimensions, temperatures, moisture contents, materials, or steps) disclosed herein unless explicitly set out in the claims. The present invention is not limited to any method of preparing the breadfruit, nor to preparing any particular fruit or food product, unless specifically set out in the claims. Further, the present invention is not limited to be applied to any particular problem disclosed herein, nor to any advantage to any process or component.

1. A process for preparing a fruit product with relatively high water content comprising the steps of:
(a) spreading chopped or shredded fruit onto a tray of a drying unit in an enclosure;
(b) moving air through the tray, thereby extracting moisture from the fruit; and
(c) exhausting moist air from the drying unit and the enclosure.

2. The process of claim 1 wherein the drying unit includes a baffle above the fruit to direct the moist air during the moving air step (b) toward exhaust fans to achieve the exhausting step (c).

3. The process of claim 2 wherein spreading step (a) includes spreading chopped or shredded fruit onto plural shelves of plural drying units, each drying unit including a baffle.

4. The process of claim 2 wherein the moving air step (b) includes drawing or pushing ambient air from outside the drying unit.

5. The process of claim 2 wherein the ambient air is heated, such as by a passive solar collector.

6. The process of claim 2 wherein the air temperature is approximately between 100 degrees F. and 130 degrees F., measured in a heated section of the enclosure.

7. The process of claim 6 wherein the air temperature is approximately 115 degrees F. to 120 degrees F.

8. The process of claim 1 wherein the fruit is breadfruit.

9. The process of claim 1 wherein the fruit comprises at least one of banana and fig.

10. A system for drying fruit comprising:
a housing;
a rack of multiple, stacked drying units, each drying unit comprising:
a shelf for receiving chopped or shredded fruit;
a baffle over the shelf for inhibiting directing air flow laterally;
at least one air source (for example, a fan) for moving air through the shelf and through the fruit; and
an exhaust fan for removing air and moisture from the fruit from the housing.

11. The system of claim 10 wherein the baffle prevents air flow from a lower rack from reaching the shelf above it.

12. The system of claim 11 wherein the exhaust fan includes plural exhaust fans such that each drying unit has one of the exhaust fans.

13. The system of claim 12 further comprising an enclosure for housing the drying units; the enclosure including an air inlet.

14. The system of claim 13 further comprising an air heater.

15. The system of claim 13 wherein the air heater is a direct solar heater, through which air is drawn by the exhaust fans.

16. The system of claim 15 wherein the air heater includes a combustor.
